(19) United States
(12) Patent Application Publication
(10) Pub. No.: US 2012/0217236 A1
(43) Pub. Date: Aug. 30, 2012

(54) RICE COOKER

(76) Inventor: Shinya Takagi, Osaka-shi (JP)

(21) Appl. No.: 13/505,967

(22) PCT Filed: Nov. 26, 2010
(86) PCT No.: PCT/JP2010/071117

§ 371 Date: May 3, 2012

(30) Foreign Application Priority Data
Dec. 1, 2009 (JP) 2009273337

(51) Int. Cl. H05B 6/22

(52) U.S. Cl. 219/647

(57) ABSTRACT

The present rice cooker includes: a follower magnet integrally formed in a rotational mixing blade to rotate and drive a rotational mixing blade; a driver magnet coupled to the follower magnet in a non-contact manner to transmit driving force; a motor for rotating the driver magnet; and a cylindrical cover having a shape of cylinder surrounding the driver magnet and engaged with a protrusion of an inner bowl for positioning. By employing such a configuration, there can be provided a rice cooker having a structure which is free from clogging with grains of rice in the case where the rotational mixing blade is provided in the inner bowl and which is capable of preventing the rotational mixing blade from falling from the inner bowl when the inner bowl is inverted.

### TECHNICAL FIELD

The present invention relates to a structure of a rice cooker.

### BACKGROUND ART

Conventionally, as disclosed in Japanese Patent Laying-Open No. 2000-308572 (hereinafter, referred to as Patent Literature 1), there has been disclosed a rice cooker including water stream generating means so as to obtain well-cooked delicious rice by circulating water in its inner bowl to improve heat transmission to the rice while suppressing generation of water vapor by controlling the heating to fall below the boiling point.

FIG. 16 shows a rice cooker 200A disclosed in FIG. 2 of Patent Literature 1. In a rice cooker main body 201, an inner bowl 202 is contained. Outside the bottom portion of this inner bowl 202, inner bowl temperature detecting means 204, inner bowl heating means 205, and water stream generating means 203 are disposed. At an inner side relative to the bottom portion of inner bowl 202, a rotational mixing blade 233 is provided in water stream generating means 203 and fixed to a rotational shaft extending through inner bowl 202. Rotational mixing blade 233 is covered with a water stream control plate 230 having a water intake port 231 and exhaust ports 232.

FIG. 17 shows a rice cooker 200B disclosed in FIG. 3 of Patent Literature 1. In a rice cooker main body 201, an inner bowl 202 is contained. Outside the bottom portion of this inner bowl 202, inner bowl temperature detecting means 204, inner bowl heating means 205, and rotational magnetic field generating means 235 are disposed. At an inner side relative to the bottom portion of inner bowl 202, a rotational mixing blade 233 having a magnet 234 is rotatably provided. Rotational mixing blade 233 and rotational magnetic field generating means 235 constitute water stream generating means 203. Rotation of rotational magnetic field generating means 235 causes rotation of rotational mixing blade 233.

Rice cooker 200A configured as above has the following problem. Water stream control plate 230 is provided to surround rotational mixing blade 233, water intake port 231 is provided above rotational mixing blade 233 in the axial direction thereof, and exhaust ports 232 are provided at locations in a direction perpendicular to the axial direction of rotational mixing blade 233, so as to secure a pumping function by water stream control plate 230 and rotational mixing blade 233.

However, this causes a large amount of grains of rice to flow into water stream control plate 230 to result in possible failure of generating water stream allowing for a mixing effect. Further, even if water intake port 231 is provided with a filter, the filter may be clogged with the grains of rice to similarly result in possible failure of generating water stream allowing for the mixing effect.

Meanwhile, rice cooker 200B configured as above has the following problem. Rice cooker 200B is configured to utilize magnetic force to attach/detach rotational magnetic field generating means 235 to/from rotational mixing blade 233. However, when inner bowl 202 is taken out from rice cooker main body 201, rotational mixing blade 233 is not bound thereto by magnetic force. Hence, when inner bowl 202 is inverted (to take out cooked rice in order to prepare vinegar flavored rice for sushi, for example), rotational mixing blade 233 is buried in the cooked rice. Further, when washing emptied inner bowl 202, rotational mixing blade 233 may fall off from inner bowl 202 to result in damage of inner bowl 202 or rotational mixing blade 233.

### CITATION LIST

### Patent Literature

PTL 1: Japanese Patent Laying-Open No. 2000-308572

### SUMMARY OF INVENTION

### Technical Problem

Thus, the problems to be solved by the present invention are as follows: the problem of possible clogging with the grains of rice in the case where the water stream control plate or the like is provided in the inner bowl in addition to the rotational mixing blade; and the problem of the rotational mixing blade being buried in the cooked rice or the problem of the rotational mixing blade falling from the inner bowl when the inner bowl is inverted in the case of employing the non-contact rotational structure utilizing magnetic force to rotate the rotational mixing blade. In view of these, the present invention has its object to provide a rice cooker having a structure which is free from clogging with grains of rice when a rotational mixing blade is provided in an inner bowl, and which is capable of preventing the rotational mixing blade from falling from the inner bowl when the inner bowl is inverted.

### Solution to Problem

A rice cooker according to the present invention includes: an inner bowl; and water stream generating means for circulating grains of rice and water contained in the inner bowl, the inner bowl having a bottom surface with a central portion in which a falling preventing magnetic material is provided, the water stream generating means being located external to the inner bowl, the water stream generating means including a driver magnetic material provided to be rotatable by driving means and a rotational mixing blade, the rotational mixing blade having a blade-side falling preventing magnetic material provided in a location facing the falling preventing magnetic material, and a follower magnetic material provided in a location facing the driver magnetic material.

At least one of the driver magnetic material and the follower magnetic material is a magnetized magnet, and at least one of the falling preventing magnetic material and the blade-side falling preventing magnetic material is a magnetized magnet.

In another embodiment of the rice cooker, the inner bowl has a side wall corresponding to an interval of about ½ of a height thereof from a location of opening of the inner bowl to the bottom surface thereof and having a shape of cylinder having an area of opening substantially as large as that of the opening, the inner bowl has a side wall corresponding to an interval of another about ½ of the height thereof to the bottom surface and inclined inwardly, and the inner bowl is provided with a bottom portion having an area smaller than the area of the opening.

In another embodiment of one of the above-described rice cookers, the rotational mixing blade has a substantially hemispherical curved shape with an outer surface having a plurality of ribs formed radially thereon.

Another rice cooker according to the present invention includes: an inner bowl; and water stream generating means for circulating grains of rice and water contained in the inner bowl, the water stream generating means being located external to the inner bowl, the water stream generating means including a driver magnetic material provided to be rotatable by driving means, and a rotational mixing blade, the rotational mixing blade having a follower magnetic material provided in a location facing the driver magnetic material.

At least one of the driver magnetic material and the follower magnetic material is a magnetized magnet, and the driver magnetic material and the follower magnetic material arc coupled to each other in a flat plane perpendicular to a rotational shaft of the driving means.

In another embodiment of the rice cooker, the inner bowl has a side wall corresponding to an interval of about ½ of a height thereof from a location of opening of the inner bowl to a bottom surface thereof and having a shape of cylinder having an area of opening substantially as large as that of the opening, the inner bowl has a side wall corresponding to an interval of another about ½ of the height thereof to the bottom surface and inclined inwardly, and the inner bowl is provided with a bottom portion having an area smaller than the area of the opening.

In another embodiment of one of the above-described rice cookers, the rotational mixing blade has a substantially hemispherical curved shape with an outer surface having a plurality of ribs formed radially thereon.

Still another rice cooker according to the present invention includes: an inner bowl; and water stream generating means for circulating grains of rice and water contained in the inner bowl, the inner bowl having a bottom surface with a central portion provided with a protrusion in which a bottom portion of the inner bowl protrudes inwardly from an outer surface side toward an inner surface side thereof.

The protrusion is provided with a protrusion-side falling preventing magnetic material, the water stream generating means being located external to the protrusion of the inner bowl, the water stream generating means including a driver magnetic material provided to be rotatable about a rotational shaft by driving means, and a rotational mixing blade having a bottom surface provided with a recess with which the protrusion of the inner bowl is engaged, the rotational mixing blade having a blade-side falling preventing magnetic material provided in a location facing the protrusion-side falling preventing magnetic material, and a follower magnetic material provided in a location facing the driver magnetic material.

At least one of the driver magnetic material and the follower magnetic material is a magnetized magnet, and at least one of the protrusion-side falling preventing magnetic material and the blade-side falling preventing magnetic material being a magnetized magnet.

In another embodiment of the rice cooker, the inner bowl has a side wall corresponding to an interval of about ½ of a height thereof from a location of opening of the inner bowl to the bottom surface thereof and having a shape of cylinder having an area of opening substantially as large as that of the opening, the inner bowl has a side wall corresponding to an interval of another about ½ of the height thereof to the bottom surface and inclined inwardly, and the inner bowl is provided with the bottom portion having an area smaller than the area of the opening.

In another embodiment of one of the above-described rice cookers, the rotational mixing blade has a substantially hemispherical curved shape with an outer surface having a plurality of ribs formed radially thereon.

In another embodiment of one of the above-described rice cookers, the protrusion of the inner bowl has an inner bowl side flat portion, the recess of the rotational mixing blade has a blade side flat portion facing the inner bowl side flat portion. and the blade side flat portion has a small protrusion protruding toward the inner bowl side flat portion.

### Advantageous Effects of Invention

According to the rice cooker in the present invention, there can be provided a rice cooker which is free from clogging with grains of rice even when a rotational mixing blade is provided in an inner bowl and which is capable of preventing the rotational mixing blade from falling from the inner bowl when the inner bowl is inverted.

### BRIEF DESCRIPTION OF DRAWINGS

FIG. 1 shows an internal structure of a rice cooker in an embodiment.

FIG. 2 is a plan view of an inner bowl employed in the rice cooker of the embodiment.

FIG. 3 is a front view of the inner bowl employed in the rice cooker of the embodiment.

FIG. 4 is a cross sectional view taken along a line IV-IV in FIG. 2.

FIG. 5 is an enlarged cross sectional view of a region surrounded by V in FIG. 4.

FIG. 6 is a plan view showing a state in which a rotational mixing blade is attached to the inner bowl of the rice cooker of the embodiment.

FIG. 7 is a cross sectional view taken along a line VII-VII in FIG. 6.

FIG. 8 shows an internal structure of the rotational mixing blade employed in the rice cooker of the embodiment.

FIG. 9 is a cross sectional view taken along a line IX-IX in FIG. 8.

FIG. 10 is a perspective view showing an external appearance of the rotational mixing blade employed in the rice cooker of the embodiment.

FIG. 11 is a plan view showing the external appearance of the rotational mixing blade employed in the rice cooker of the embodiment.

FIG. 12 is a front view showing the external appearance of the rotational mixing blade employed in the rice cooker of the embodiment.

FIG. 13 is a bottom view showing the external appearance of the rotational mixing blade employed in the rice cooker of the embodiment.

FIG. 14 is a cross sectional view taken along a line XIV-XIV in FIG. 11.

FIG. 15 is a cross sectional view taken along a line XV-XV in FIG. 14.

FIG. 16 shows an internal structure of a rice cooker in a background art.

FIG. 17 shows an internal structure of a rice cooker in the background art.

### DESCRIPTION OF EMBODIMENTS

The following describes a rice cooker in each embodiment according to the present invention with reference to figures. It should be noted that the below-described embodiment is exemplary and the present invention can be implemented in various forms within the scope of the present invention. Further, unless particularly noted, the number, amount, and the like described in the below-described embodiment are not necessarily limiting the scope of the present invention to these number, amount, and the like. Furthermore, the same or corresponding components are given the same reference characters and may not be described repeatedly.

(Schematic Configuration of Rice Cooker 100)

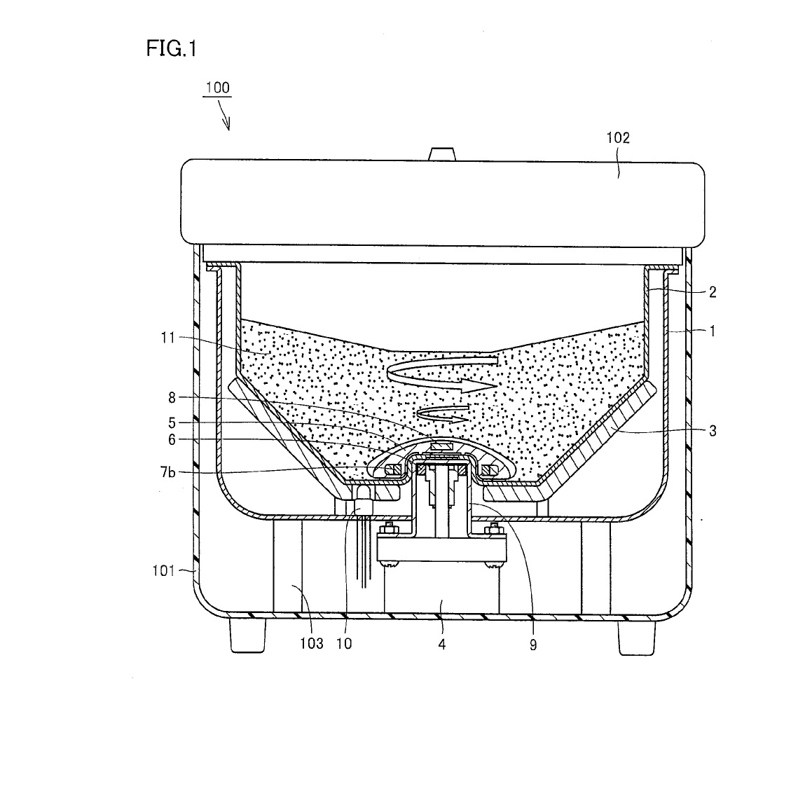

FIG. 1 shows an internal structure of a rice cooker in an embodiment according to the present invention. This rice cooker 100 has a rice cooker main body container 101 in which an outer pot 1 is provided to contain an inner bowl 2 made of aluminum, which is a non-magnetic material. Outer pot 1 is supported by supporting members 103 relative to rice cooker main body container 101.

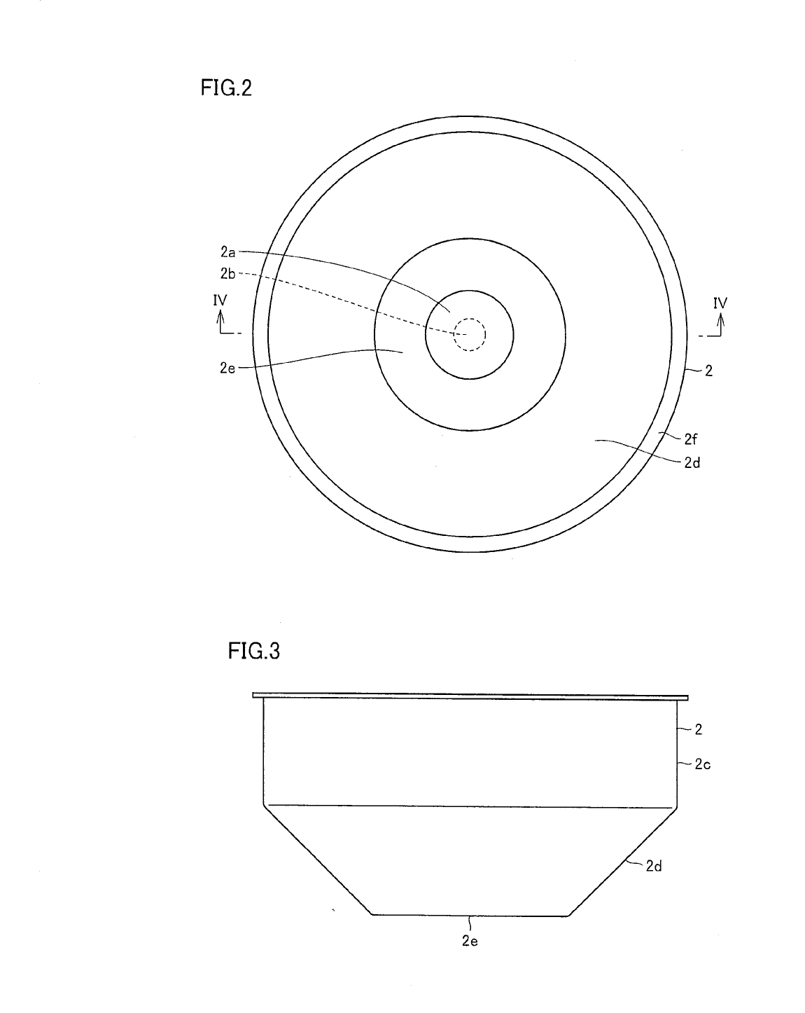

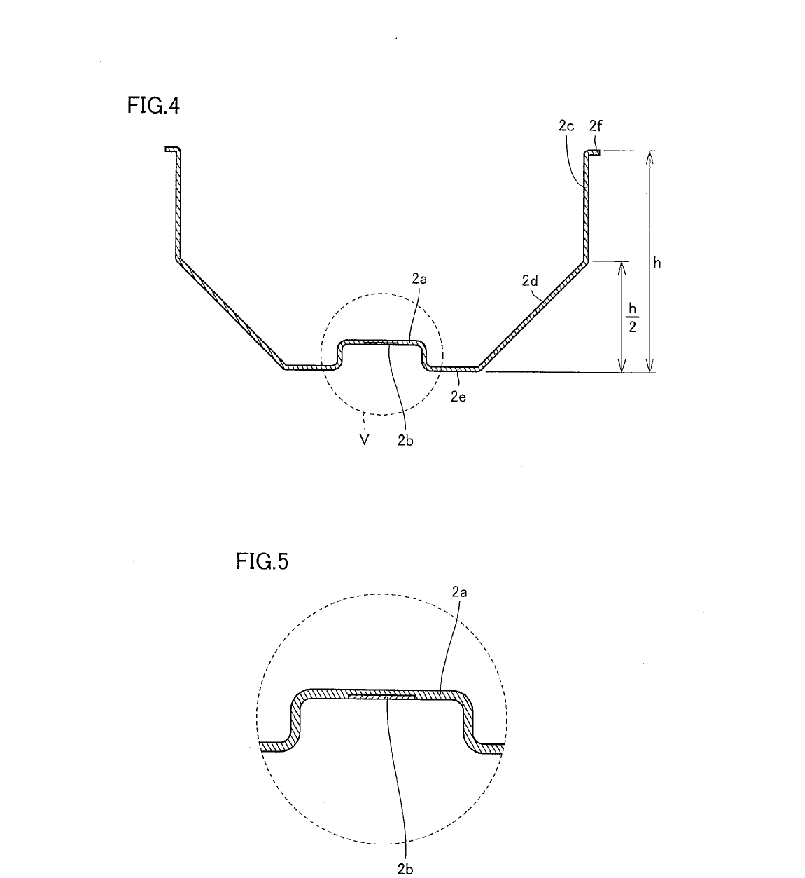

Further, rice cooker main body container 101 includes: heaters 3 serving as heating means for inner bowl 2; an inner bowl temperature sensor 10 for adjusting output of heaters 3; a rotational mixing blade 5 contained in inner bowl 2 to mix and circulate a contained object 11 made up of grains of rice and water; follower magnets 7b integrally formed in rotational mixing blade 5 to rotate and drive rotational mixing blade 5; driver magnets 6 coupled to follower magnets 7b in a non-contact manner to transmit driving force; a motor 4 for rotating driver magnets 6; and a cylindrical cover 9 surrounding driver magnets 6 and engaged with a protrusion 2a (see FIG. 2 and FIG. 4) of inner bowl 2 for positioning.

In an operation of rice cooker 100, rotation of motor 4 is transmitted to rotational mixing blade 5 in inner bowl 2 by means of magnetic force to rotate rotational mixing blade 2, thereby generating water stream to mix contained object 11 in inner bowl 2. It should be noted that heaters 3 are one example of the heating means and other heating means usable includes gas heating and induction heating.

(Details of Structure of Inner Bowl 2)

Referring to FIG. 2 to FIG. 5, the following describes details of the structure of inner bowl 2. FIG. 2 is a plan view of inner bowl 2. FIG. 3 is a front view of the inner bowl. FIG. 4 is a cross sectional view taken along a line IV-IV in FIG. 2. FIG. 5 is an enlarged cross sectional view of a region surrounded by V in FIG. 4.

Inner bowl 2 is obtained through a molding process of aluminum, which is a non-magnetic material. As shown in FIG. 4, assuming that the height of inner bowl 2 is h, inner bowl 2 has a side wall 2c corresponding to an interval of about ½ of the height thereof from the location of opening of inner bowl 2 to the bottom surface thereof (h/2) and having a shape of cylinder having an area of opening substantially as large as that of the foregoing opening. Inner bowl 2 also has a side wall 2d corresponding to an interval of another about ½ of the height thereof to the bottom surface thereof and inclined inwardly. Thus, bottom portion 2e of inner bowl 2 has an area smaller than the area of the opening.

At the upper end portion of side wall 2c, a flange portion 2f is provided to project outwardly. Further, at the substantially central portion of bottom portion 2e of inner bowl 2, protrusion 2a is provided in which bottom portion 2e of inner bowl 2 inwardly protrudes from the outer surface side to the inner surface side thereof. Protrusion 2a is in the form of a hat having an inner bowl side flat portion. A magnetic plate 2b is provided in the inner bowl side flat portion of protrusion 2a (see FIG. 5).

The inclination of side wall 2d is particularly effective in the case where an amount of grains of rice to be cooked is small. The inclination of side wall 2d allows water stream, which is radially generated through centrifugal force provided by rotational mixing blade 5, to spontaneously flow back to the center thereof. With such a cycle, mixing with the water stream can be done without stagnation. As the inclination is steeper in angle, the spontaneous flow is facilitated but the capacity of inner bowl 2 will be decreased unless the diameter of inner howl 2 is made larger. Hence, the inclination may be set at such an angle that the size of inner bowl 2 and the water stream are appropriately balanced.

Protrusion 2a formed in inner bowl 2 is used to serve as a rotational shaft of rotational mixing blade 5. The opposite surface of inner bowl 2 to protrusion 2a provides a recess. Cylindrical cover 9 having a shape of cylinder with a bottom is engaged with the recess to position driver magnet 6 and prevent collision, thereby forming magnetic coupling therebetween. Protrusion 2a formed in inner bowl 2 is dimensioned to have a cylindrical shape with a diameter of about 40 mm and a height of about 10 mm, for example. The diameter of about 40 mm and the height of about 10 mm thus employed achieve a shape of protrusion that can be relatively readily washed because it does not protrude too high and does not protrude too small when rotational mixing blade 5 is detached.

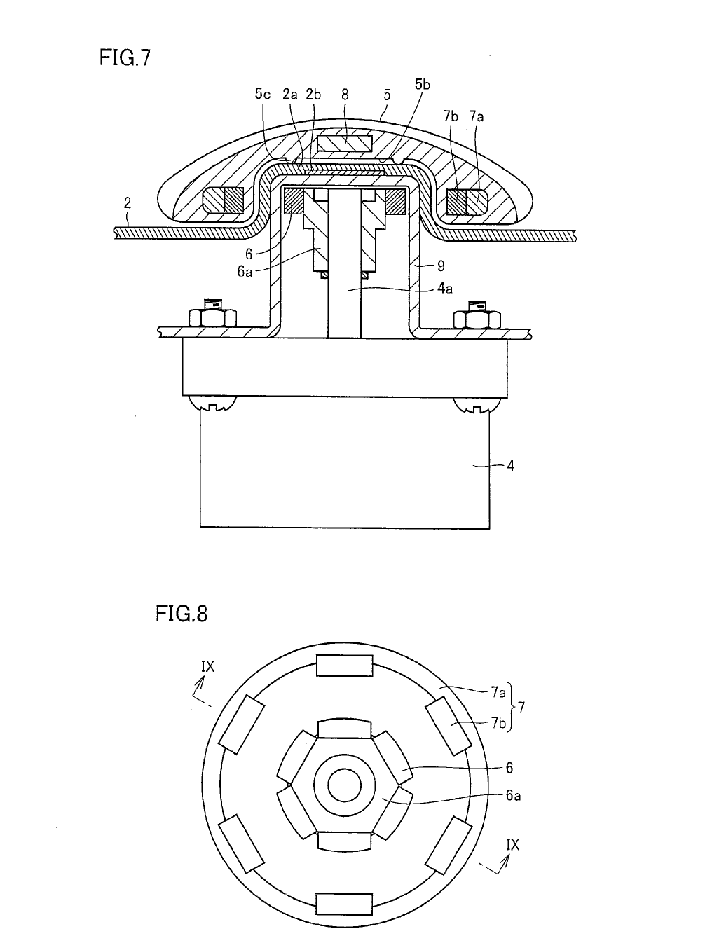

Magnetic plate 2b, which is provided in protrusion 2a at its outer surface side, operates with a falling preventing magnet 8 (see FIG. 7), which is provided and sealed in rotational mixing blade 5, to provide a drawing effect through magnetic force. Specifically, magnetic plate 2b serves to provide magnetic force to prevent rotational mixing blade 5 from readily falling from inner bowl 2 when inner bowl 2 is taken out. It should be noted that a magnet may be provided in protrusion 2a at its outer surface side and a falling preventing magnetic material may be sealed in rotational mixing blade 5. Further, falling preventing magnets can be used in both protrusion 2a and rotational mixing blade 5.

According to this configuration, the area of the bottom portion of inner bowl 2 is smaller than the area of opening of inner bowl 2 and protrusion 2a is formed at the center of the internal bottom surface of inner bowl 2, thereby providing side wall surface 2d inclined to direct contained object 11, which includes water and a small amount of grains of rice to be cooked (smaller than two Japanese measuring cups), toward the central portion thereof. Accordingly, when water stream is generated by rotation of rotational mixing blade 5, the grains of rice are brought up toward the side wall 2d side and then flows back to the central portion of inner bowl 2 due to gravity. In this way, even though the capacity of inner bowl 2 is not so small, the mixing effect can he obtained in cooking a small amount of grains of rice.

It has been illustrated that the location from which side wall 2d is inclined inwardly is the location at h/2, i.e., the half of the height of inner bowl 2, but is not limited to the location at h/2. With the area of the bottom portion of inner bowl 2 being smaller than the area of opening of inner bowl 2, it can be expected to achieve improved mixing effect when cooking a small amount of grains of rice.

(Magnetic Coupling and Configuration of Rotational Mixing Blade 5)

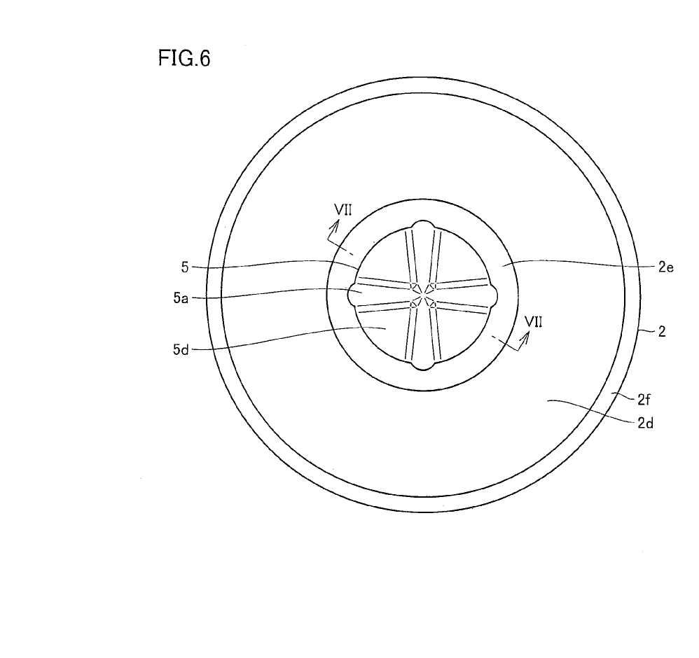

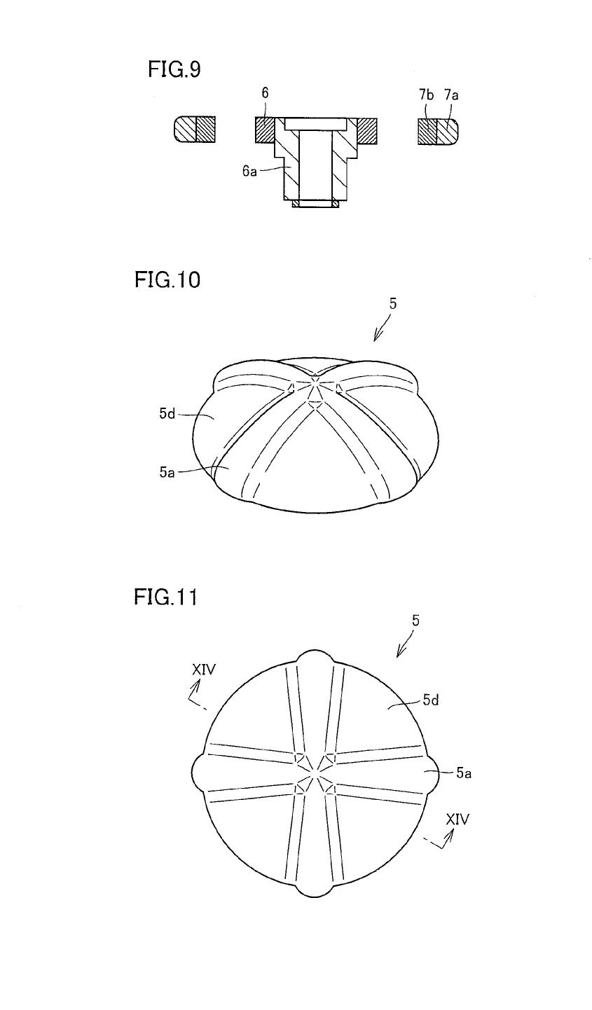

Referring to FIG. 6 to FIG. 9, the following describes the magnetic coupling and the configuration of rotational mixing blade 5. FIG. 6 is a plan view showing a state in which rotational mixing blade 5 is attached to inner bowl 2. FIG. 7 is a cross sectional view taken along a line VII-VII. FIG. 8 shows the internal structure of rotational mixing blade 5. FIG. 9 is a cross sectional view taken along a line IX-IX in FIG. 8. Cylindrical cover 9 is engaged with the recess formed at the outer surface of inner bowl 2 and constituted by protrusion 2a. In cylindrical cover 9, motor 4 is provided with a rotational shaft 4a to which an inner yoke 6a having driver magnets 6 attached thereto is fixed. Six driver magnets 6 are provided on the circumference thereof at an equal pitch. Further, recess 5b of rotational mixing blade 5 integrally formed of a fluorine resin or the like is rotatably engaged with the inner surface side of protrusion 2a of inner bowl 2.

Thus, recess 5b of rotational mixing blade 5 is engaged with the inner surface side of protrusion 2a of inner bowl 2 and cylindrical cover 9 is engaged with the outer surface side of protrusion 2a of inner bowl 2, thereby precisely positioning driver magnets 6 and follower magnets 7b. Further, with cylindrical cover 9 being provided, the outer surface of inner bowl 2 is not in direct contact with driver magnets 6, thereby protecting inner bowl 2 from damage.

Rotational mixing blade 5 has an outer yoke 7a having an annular shape. In outer yoke 7a, six follower magnets 7b in total are provided in locations facing driver magnets 6 and arc therefore positioned to achieve balanced magnetic force between driver magnets 6 and follower magnets 7b. Falling preventing magnet 8 is sealed in the central portion of rotational mixing blade 5 (see FIG. 7, FIG. 14, and FIG. 15). Driver magnetic materials 6 and follower magnetic materials 7b are coupled (magnetically coupled) to each other in a flat plane perpendicular to rotational shaft 4a of motor 4. In this way, canceling of the magnetic coupling can be effectively reduced during rotation, thereby securing mixing performance.

When inner bowl 2 is detached from outer pot 1, as described above, magnetic plate 2b provided in protrusion 2a of inner bowl 2 and falling preventing magnet 8 integrally formed in the center of rotational mixing blade 5 draw each other to prevent rotational mixing blade 5 from falling naturally while permitting detachment thereof with intentional external force.

It has been illustrated that a magnet is used for each of driver magnets 6 and follower magnets 7b, but at least one of driver magnet 6 and follower magnet 7b may be a magnetized magnet and the other may be a magnetic material.

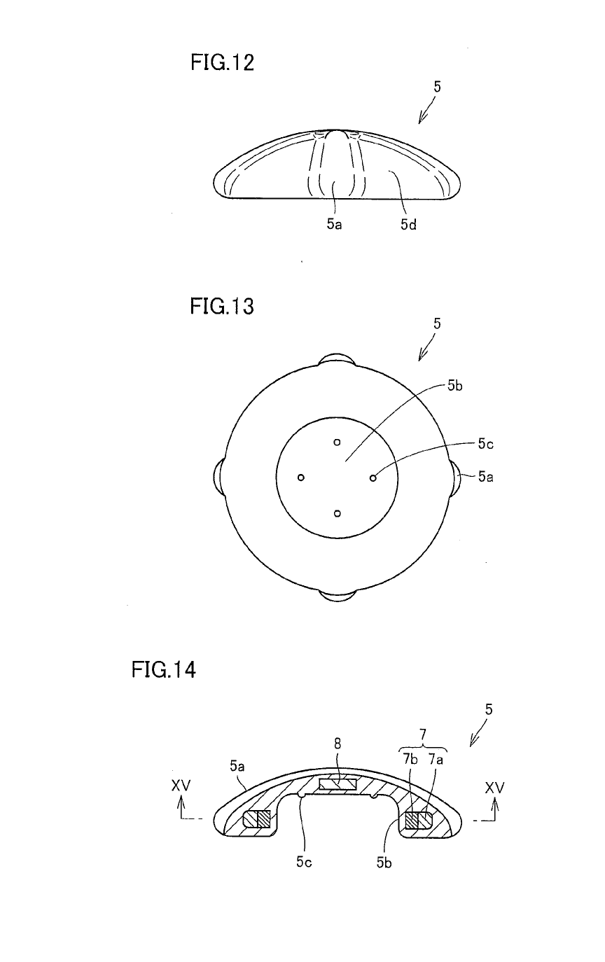

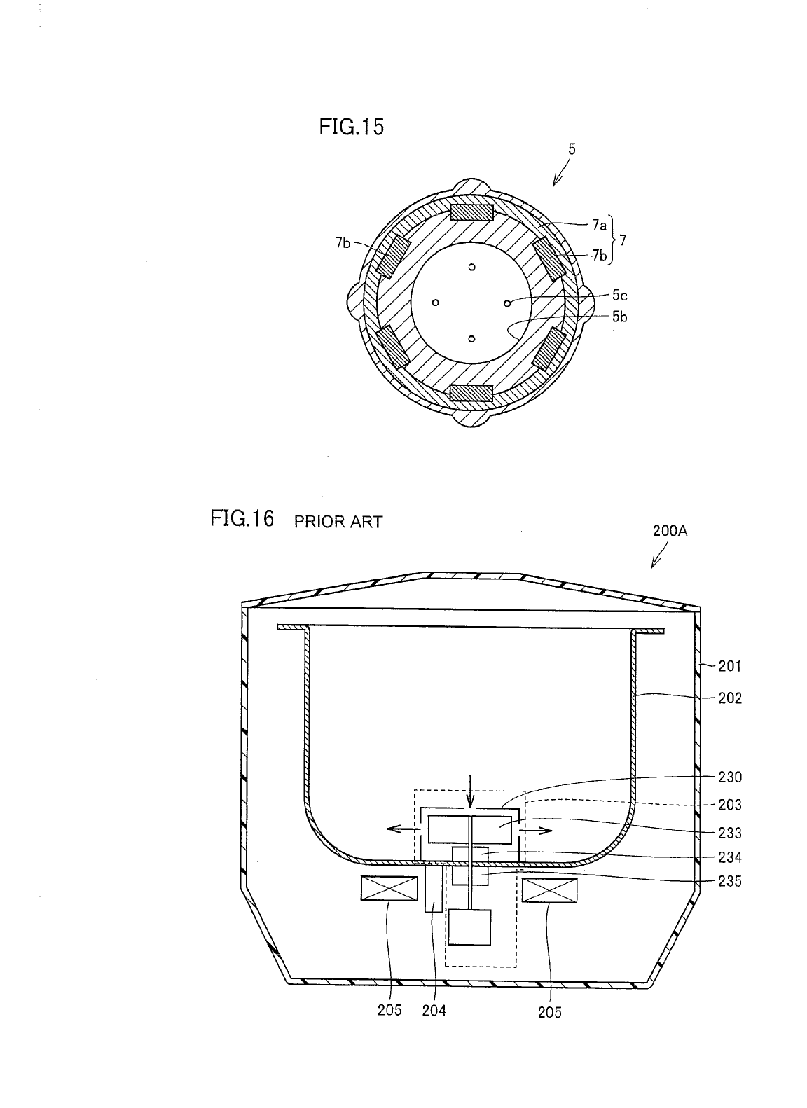

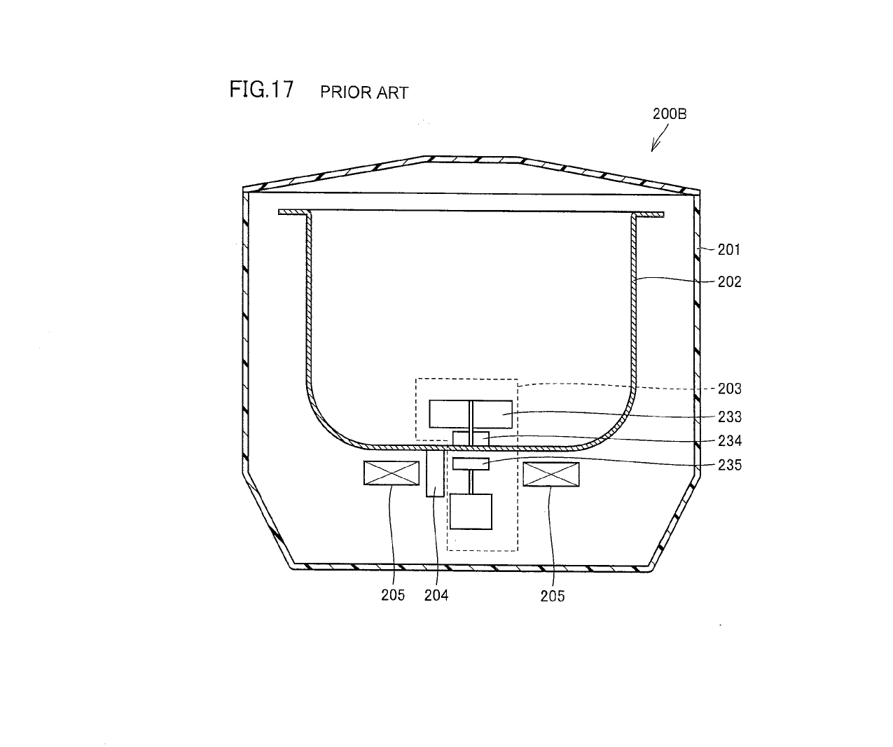

Referring to FIG. 10 to FIG. 13, the following describes an external appearance of rotational mixing blade 5. FIG. 10 is a perspective view showing the external appearance of rotational mixing blade 5. FIG. 11 is a plan view showing the external appearance of rotational mixing blade 5. FIG. 12 is a front view showing the external appearance of the rotational mixing blade. FIG. 13 is a bottom view showing the external appearance of the rotational mixing blade.

Rotational mixing blade 5 has four water stream generating ribs 5a at its outer surface having a substantially semicircular shape formed by a circular curved surface. Water stream generating ribs 5a are arranged in the form of a cross. In rotational mixing blade 5, follower magnets 7b and falling preventing magnet 8 described above are integrally formed by means of a fluorine resin or the like. Rotational mixing blade 5 is dimensioned to have a substantially hemispherical shape having a diameter of about 60 mm to about 70 mm and a height of about 15 mm to about 20 mm. It should be noted that the number of water stream generating ribs 5a is not limited to four.

Because rotational mixing blade 5 has such an outer surface having a substantially semicircular shape formed by a circular curved surface, a rice scoop is slid along the curved surface. Moreover, the fluorine resin material has a low friction and is therefore slippery for the rice scoop when being in contact therewith, thereby facilitating scooping of the cooked rice while allowing for generation of the water stream. The shape of the outer surface of rotational mixing blade 5, and the shape and number of the ribs are not limited to the above and may be any shapes and number as long as they exhibit a similar effect or the same effect.

Further, a plurality of small protrusions 5c are provided in the flat portion of recess 5b provided in rotational mixing blade 5 at the inner surface side thereof and to be engaged with protrusion 2a of inner bowl 2, so as to protrude toward the flat portion of protrusion 2a of inner bowl 2. Small protrusions 5c thus provided allow protrusion 2a of inner bowl 2 and recess 5b of rotational mixing blade 5 to make point contact with each other.

Further, when the magnetic force of driver magnet 6 and the magnetic force of follower magnet 7b are balanced to a location where small protrusions 5c are not in contact with the upper surface of protrusion 2a of inner bowl 2, rotational mixing blade 5 is slightly floated while being rotated. Accordingly, load is reduced even when they are brought into contact with each other due to influences of the water stream and the weight of grains of rice.

As a result, when rotational mixing blade 5 is engaged with protrusion 2a of inner bowl 2, they are in point contact with each other. Accordingly, a rotation system with a small sliding resistance is provided, thereby achieving low power driving and less friction, which leads to improved durability. Accordingly, long-term deterioration of the rotating portion can be suppressed, and rotational vibration and rotational sound are suppressed from being large, thereby achieving improved long-term reliability of the rice cooker.

Thus, the use of the rice cooker according to the present embodiment provides the following considerable effects: even when cooking a small amount of grains of rice, the grains of rice can be sufficiently circulated by water stream without causing clogging with the grains of rice; rotational mixing blade 5 does not greatly hinder scooping of cooked rice; rotational mixing blade 5 can be readily cleaned and prevented from falling accidentally; and the rotating portion is high in reliability.

Although the embodiments of the present invention have been described, the embodiments disclosed herein are illustrative and non-restrictive in any respect. The scope of the present invention is defined by the terms of the claims, and is intended to include any modifications within the scope and meaning equivalent to the terms of the claims.

### REFERENCE SIGNS LIST

1: outer pot; 2: inner bowl; 2a: protrusion; 2b: magnetic plate; 2c, 2d: side wall; 2e: bottom portion; 2f: flange portion; 3: heater; 4: motor; 4a: rotational shaft; 5: rotational mixing blade; 5a: water stream generating rib; 5b: recess; 5c: small protrusion; 6: driver magnet; 6a: inner yoke; 7a: outer yoke; 7b: follower magnet; 8: falling preventing magnet; 9: cylindrical cover; 10: inner bowl temperature sensor; 11:

contained object (grains of rice and water); 100: rice cooker; 101: rice cooker main body container; 103: supporting member.

1. A rice cooker comprising:
an inner bowl; and
water stream generating means for circulating grains of rice and water contained in said inner bowl,
said inner bowl having a bottom surface with a central portion in which a falling preventing magnetic material is provided,
said water stream generating means being located external to said inner bowl, said water stream generating means including a driver magnetic material provided to be rotatable by driving means and a rotational mixing blade,
said rotational mixing blade having a blade-side falling preventing magnetic material provided in a location facing said falling preventing magnetic material, and a follower magnetic material provided in a location facing said driver magnetic material,
at least one of said driver magnetic material and said follower magnetic material being a magnetized magnet,
at least one of said falling preventing magnetic material and said blade-side falling preventing magnetic material being a magnetized magnet.

2. The rice cooker according to claim 1, wherein said inner bowl has a side wall corresponding to an interval of about ½ of a height thereof from a location of opening of said inner bowl to the bottom surface thereof and having a shape of cylinder having an area of opening substantially as large as that of said opening, said inner bowl has a side wall corresponding to an interval of another about ½ of the height thereof to the bottom surface and inclined inwardly, and said inner bowl is provided with a bottom portion having an area smaller than the area of said opening.

3. The rice cooker according to claim 1, wherein said rotational mixing blade has a substantially hemispherical curved shape with an outer surface having a plurality of ribs formed radially thereon.

4. A rice cooker comprising:
an inner bowl; and
water stream generating means for circulating grains of rice and water contained in said inner bowl,
said water stream generating means being located external to said inner bowl, said water stream generating means including a driver magnetic material provided to be rotatable by driving means, and a rotational mixing blade,
said rotational mixing blade having a follower magnetic material provided in a location facing said driver magnetic material,
at least one of said driver magnetic material and said follower magnetic material being a magnetized magnet,
said driver magnetic material and said follower magnetic material being coupled to each other in a flat plane perpendicular to a rotational shaft of said driving means.

5. The rice cooker according to claim 4, wherein said inner bowl has a side wall corresponding to an interval of about ½ of a height thereof from a location of opening of said inner bowl to a bottom surface thereof and having a shape of cylinder having an area of opening substantially as large as that of said opening, said inner bowl has a side wall corresponding to an interval of another about ½ of the height thereof to the bottom surface and inclined inwardly, and said inner bowl is provided with a bottom portion having an area smaller than the area of said opening.

6. The rice cooker according to claim 4, wherein said rotational mixing blade has a substantially hemispherical curved shape with an outer surface having a plurality of ribs formed radially thereon.

7. A rice cooker comprising:
an inner bowl; and
water stream generating means for circulating grains of rice and water contained in said inner bowl,
said inner bowl having a bottom surface with a central portion provided with a protrusion in which a bottom portion of said inner bowl protrudes inwardly from an outer surface side toward an inner surface side thereof,
said protrusion being provided with a protrusion-side falling preventing magnetic material,
said water stream generating means being located external to said protrusion of said inner bowl, said water stream generating means including a driver magnetic material provided to be rotatable about a rotational shaft by driving means, and a rotational mixing blade having a bottom surface provided with a recess with which said protrusion of said inner bowl is engaged,
said rotational mixing blade having a blade-side falling preventing magnetic material provided in a location facing said protrusion-side falling preventing magnetic material, and a follower magnetic material provided in a location facing said driver magnetic material,
at least one of said driver magnetic material and said follower magnetic material being a magnetized magnet,
at least one of said protrusion-side falling preventing magnetic material and said blade-side falling preventing magnetic material being a magnetized magnet.

8. The rice cooker according to claim 7, wherein said inner bowl has a side wall corresponding to an interval of about ½ of a height thereof from a location of opening of said inner bowl to the bottom surface thereof and having a shape of cylinder having an area of opening substantially as large as that of said opening, said inner bowl has a side wall corresponding to an interval of another about ½ of the height thereof to the bottom surface and inclined inwardly, and said inner bowl is provided with the bottom portion having an area smaller than the area of said opening.

9. The rice cooker according to claim 7, wherein said rotational mixing blade has a substantially hemispherical curved shape with an outer surface having a plurality of ribs formed radially thereon.

10. The rice cooker according to claim 7, wherein:
said protrusion of said inner bowl has an inner bowl side flat portion, said recess of said rotational mixing blade has a blade side flat portion facing said inner bowl side flat portion, and
said blade side flat portion has a small protrusion protruding toward said inner bowl side flat portion.
